(19) United States
(12) Patent Application Publication
(10) Pub. No.: US 2016/0143038 A1
(43) Pub. Date: May 19, 2016

(54) TERMINAL DEVICE, BASE STATION DEVICE, WIRELESS COMMUNICATION SYSTEM, AND COMMUNICATION METHOD

(71) Applicant: SHARP KABUSHIKI KAISHA, Osaka-shi, Osaka (JP)

(72) Inventors: Jungo GOTO, Osaka-shi, Osaka (JP); Osamu NAKAMURA, Osaka-shi, Osaka (JP); Yasuhiro HAMAGUCHI, Osaka-shi, Osaka (JP)

(73) Assignee: SHARP KABUSHIKI KAISHA, Osaka-shi, Osaka (JP)

(21) Appl. No.: 14/896,242

(22) PCT Filed: Jun. 4, 2014
(86) PCT No.: PCT/JP2014/064829

§ 371 Date: Dec. 4, 2015

(30) Foreign Application Priority Data
Jun. 6, 2013 (JP) 2013-119378

(51) Int. Cl. H04W 72/04; H04L 5/00

(52) U.S. Cl. CPC H04W 72/0466; H04L 5/0048

(57) ABSTRACT

A terminal device receives a frequency resource allocation for data transmission configured of a plurality of subframes and notified from a base station device, the terminal device being provided with an orthogonal sequence generation unit that generates an orthogonal sequence to be applied to a reference signal, in accordance with the number of the plurality of subframes allocated.

### TECHNICAL FIELD

The present invention relates to a terminal device, a base station device, a wireless communication system, and a communication method.

The present application claims priority on the basis of Japanese Patent Application No. 2013-119378 filed in Japan on Jun. 6, 2013, the contents of which are cited herein.

### BACKGROUND ART

Standardization of the Long Term Evolution (LTE) system (Rel. 8 and Rel. 9), which is a 3.9^{th} generation portable telephone wireless communication system, has been completed, and at present, as one fourth generation wireless communication system, the standardization of the LTE-Advanced (also referred to as LTE-A, IMT-A, and so forth) system (Rel. 10 and thereafter), in which the LTE system is further developed, is being carried out.

In Rel. 12 of the LTE-A system, a scenario is being studied in which pico base station devices (pico eNBs; also referred to as evolved Node Bs, a small cells, low power nodes, and so forth) having a small cell coverage are densely arranged. A situation is also envisaged in which terminal devices (user devices, UEs, and mobile station devices) connected to a pico base station device have a slow movement speed and a small delay spread. Therefore, it is envisaged that the channels of the terminal devices connected to the pico base station device exhibit little frequency and time fluctuation.

A plurality of techniques have been proposed to improve spectral efficiency in a scenario in which there are many terminal devices that exhibit little channel fluctuation, and one of these includes reducing demodulation reference signals (DMRSs), which are reference signals that are used for demodulation (see NPL 1). For example, a proposal has been made to reduce the DMRSs that are present in 12 resource elements (REs) per one resource block (RB) and one subframe to four REs in a downlink (communication from a base station device to a terminal device). However, one subframe is configured from 14 orthogonal frequency division multiplexing (OFDM) symbols, and one RE is configured from 12 subcarriers. Furthermore, there has been a proposal to reduce the DMRSs that are present in two OFDM symbols per one subframe to one OFDM symbol in an uplink (communication from a terminal device to a base station device). With regard to an uplink, when the DMRSs are reduced to one OFDM symbol, orthogonal cover codes (OCCs) that are introduced for single user multiple-input multiple-output (SU-MIMO) and multi-user MIMO (MU-MIMO) can no longer be applied. This is because an OCC applies [+1 +1] and [+1 −1] orthogonal sequences having a sequence length of two to DMRSs that are present in two OFDM symbols within one subframe, and an orthogonal sequence having a length of two can no longer be used when the DMRSs are reduced.

Multi-subframe scheduling (also referred to as MSS and multi-TTI scheduling) has been proposed as another technique for improving spectral efficiency (see NPL 1). In MSS, a plurality of continuous subframes are allocated. In specifications prior to Rel. 11, one subframe is the only resource with which scheduling can be performed using one piece of control information. However, in the case where semi-persistent scheduling is used, a usable resource is allocated periodically. Therefore, it has been necessary to perform scheduling using a plurality of pieces of control information in the case where continuous subframes are allocated. However, by using MSS, continuous subframes can be allocated with one piece of control information, and it therefore becomes possible to reduce the amount of control information.

A method for applying OCCs in the case where both a reduction in DMRSs to one OFDM symbol and MSS are supported in an uplink is being studied (see NPL 2). In NPL 2, it is proposed that OCCs be applied across two subframes while maintaining the OCC length at two in the case where DMRSs are constituted by only one OFDM symbol within one subframe.

### CITATION LIST

### Non Patent Literature

NPL 1: Huawei, HiSilicon, “Analysis on Control Signaling Enhancements”, R1-130892, Apr. 15-19, 2013
NPL 2: ZTE, “Evaluation on the Uplink DMRS Overhead Reduction of Small Cells”, R1-131052, Apr. 15-19, 2013

### SUMMARY OF INVENTION

### Technical Problem

However, when an OCC having a sequence length of two (2-length OCC) that is the same as in the past is applied even in the case where three subframes or more are allocated by MSS, the number of terminal devices with which multiplexing by OCC is possible cannot be increased to more than two, and the number of spatial multiplexes cannot be increased. Therefore, there has been a problem in that the spectral efficiency improvement effect is limited. In addition, there has been a problem in that there is a limit to the number of multiplexes for MU-MIMO in which the used bandwidth is different.

An aspect of the present invention takes the aforementioned points into consideration, and provides a terminal device, a base station device, and a wireless communication system with which the OCC application method is switched in accordance with the number of subframes allocated by MSS.

### Solution to Problem

(1) The present invention has been devised in order to solve the aforementioned problems, and an aspect of the present invention is a terminal device that receives a frequency resource allocation for data transmission configured of a plurality of subframes and notified from a base station device, the terminal device being provided with an orthogonal sequence generation unit that generates an orthogonal sequence to be applied to a reference signal, in accordance with the number of the plurality of subframes allocated.

(2) Furthermore, in an aspect of the present invention, the orthogonal sequence generation unit determines the length of the orthogonal sequence to be generated, in accordance with the number of the plurality of subframes allocated.

(3) Furthermore, in an aspect of the present invention, the orthogonal sequence generation unit implements the orthogonal sequence to be applied, as a Walsh code.

(4) Furthermore, in an aspect of the present invention, the orthogonal sequence generation unit switches the orthogonal sequence to be applied to the reference signal, between a Walsh code and an orthogonal sequence generated by phase rotation, in accordance with the number of the plurality of subframes allocated.

(5) Furthermore, in an aspect of the present invention, the orthogonal sequence generation unit switches the orthogonal sequence to be applied to the reference signal, between one orthogonal sequence and a combination of a plurality of orthogonal sequences, in accordance with the number of the plurality of subframes allocated.

(6) Furthermore, in an aspect of the present invention, the orthogonal sequence generation unit determines the length of the orthogonal sequence to be applied to the reference signal, in accordance with the number of the plurality of subframes allocated and the number of symbols of a demodulation reference signal present in one subframe.

(7) Furthermore, an aspect of the present invention is a transmission method in which a frequency resource allocation for data transmission configured of a plurality of subframes and notified from a base station device is received and data transmission is performed, the transmission method including: a step in which the length of an orthogonal sequence is determined in accordance with the number of the plurality of subframes allocated; and a step in which a transmission signal is generated by a step in which a sequence having the determined length of the orthogonal sequence is generated, and a step in which a reference signal is multiplied by the generated orthogonal sequence.

### Advantageous Effects of Invention

According to an aspect of the present invention, by switching the OCC application method in accordance with the number of subframes allocated by MSS, the number of users multiplexed can be increased, and it becomes possible to improve spectral efficiency.

### BRIEF DESCRIPTION OF DRAWINGS

FIG. 1 is a drawing depicting a frame configuration of an uplink of the LTE system.

FIG. 2 is a drawing depicting an example of a frame configuration in which DMRSs are reduced according to the present invention.

FIG. 3 is a schematic block diagram depicting an example of a configuration of a terminal device according to the present invention.

FIG. 4 is a drawing depicting an example of a frame of transmission data of multi-subframe scheduling according to the present invention.

FIG. 5 is a schematic block diagram depicting an example of a configuration of a base station device according to the present invention.

FIG. 6 is a conventional table of CS indexes and OCCs.

FIG. 7 is an example of a table of CS indexes and OCCs according to a first embodiment.

FIG. 8 is an example of the application of OCC sequences according to the first embodiment.

FIG. 9 is an example of the application of OCC sequences having different lengths according to the first embodiment.

FIG. 10 is an example of a table of CS indexes and OCCs according to the first embodiment.

FIG. 11 is an example of a table of CS indexes and OCCs according to the first embodiment.

FIG. 12 is an example of a table of CS indexes and OCCs according to a second embodiment.

FIG. 13 is an example of a table of CS indexes and OCCs according to the second embodiment.

FIG. 14 is an example of the application of OCC sequences having different lengths according to the second embodiment.

FIG. 15 is an example of a table of CS indexes and OCCs according to a third embodiment.

FIG. 16 is an example of the application of OCC sequences having different lengths according to the third embodiment.

### DESCRIPTION OF EMBODIMENTS

Hereinafter, embodiments of the present invention will be described with reference to the drawings. In each embodiment hereinafter, a transmission device that performs data transmission is assumed to be a terminal device (user device, UE, or mobile station device), and a reception device that receives data is assumed to be a base station device (eNB; evolved Node B). Furthermore, the present invention is described on the premise of the LTE system but may also be applied to another system such as a wireless LAN or a mobile WiMAX (IEEE 802.16e).

### First Embodiment

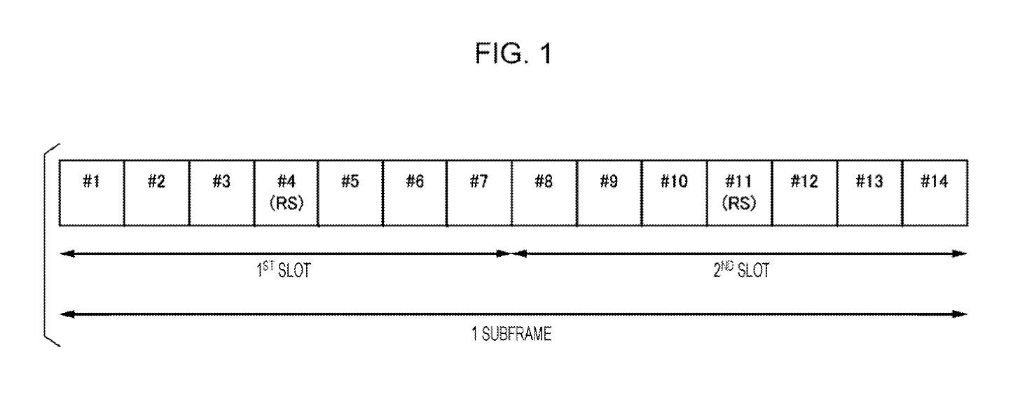

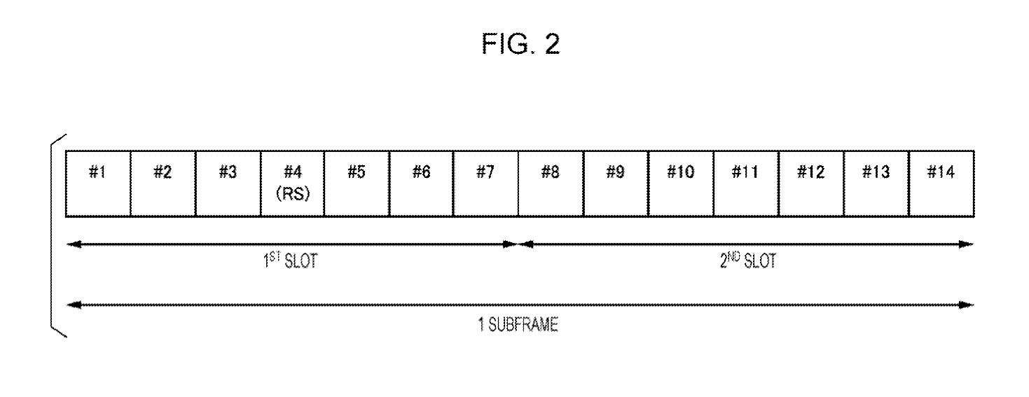

FIG. 1 depicts an example of a subframe configuration of an uplink of the LTE system. One subframe is configured from two slots, and one OFDM slot is configured from seven orthogonal frequency division multiplexing (OFDM) symbols. The fourth OFDM symbol of each slot is a demodulation reference signal (DMRS), and the other OFDM signals are data signals. However, with regard to the transmission timing for a sounding reference signal (SRS), the last OFDM symbol of a subframe becomes an SRS. FIG. 2 is an example of a frame configuration in which the DMRSs are reduced according to the present invention. In the example of this drawing, the RS of the second slot is removed, and a DMRS is only present in one OFDM in one subframe. However, in the case where the DMRSs are reduced to one OFDM symbol, the DMRS may be arranged in a symbol at any position.

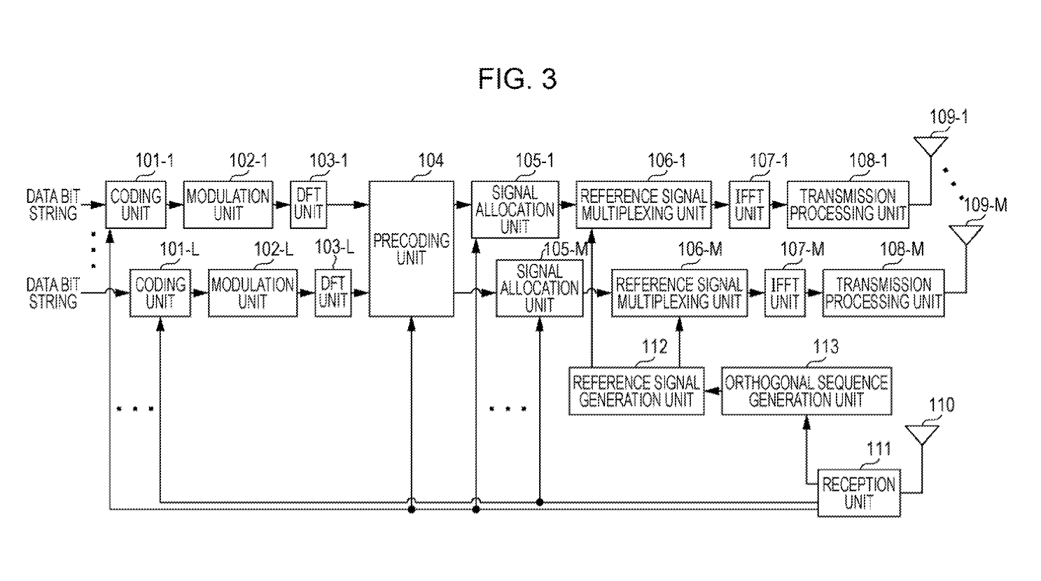

A schematic block diagram depicting an example of a configuration of a terminal device according to the present invention is depicted in FIG. 3. In the terminal device of FIG. 3, data bit strings are input to coding units 101-1 to 101-L. Hereinafter, the coding units 101-1 to 101-L to transmission antennas 109-1 to 109-L respectively perform the same processing, and therefore only the processing of the coding unit 101-1 to the transmission antenna 109-1 will be described.

The coding unit 101-1 carries out coding for error correction codes with respect to input data bit strings. For the error correction codes, for example, turbo codes, low density parity check (LDPC) codes, convolutional codes, or the like are used. The type of error correction codes implemented by the coding unit 101-1 may be predetermined by a transmission/reception device, or may be notified as control information at each transmission/reception opportunity. The coding unit 101-1 performs puncturing with respect to a coding bit string on the basis of a coding rate included in a modulation and coding scheme (MCS) notified from a base station device by a physical downlink control channel (PDCCH). The coding unit 101-1 outputs the punctured coding bit string to a modulation unit 102-1.

Although not depicted, the modulation unit 102-1 has a modulation scheme notified from the base station device by the PDCCH input thereto, carries out modulation with respect to the coding bit string input from the coding unit 101-1, and thereby generates a modulated symbol sequence. An example of the modulation scheme is quaternary phase shift keying (QPSK), 16-ary quadrature amplitude modulation (16QAM), 64QAM, or the like. The modulation unit 102-1 outputs the generated modulated symbol sequence to a DFT unit 103-1. The DFT unit 103-1 converts the modulated symbol sequence from a time-domain signal sequence into a frequency-domain signal sequence, and outputs the frequency-domain signal sequence to a precoding unit 104. The precoding unit 104 multiplies frequency-domain signal sequences input from the DFT units 103-1 to 103-L by a precoding matrix on the basis of a precoding matrix indicator (PMI) notified from the base station device by the PDCCH, and generates and outputs a signal for each antenna port to signal allocation units 105-1 to 105-M.

Meanwhile, downlink control information (DCI), which is control information transmitted from the base station device by the PDCCH, is received at a reception antenna 110. For the DCI notification method, a plurality of formats are stipulated according to use, such as uplink or downlink resource allocation. As DCI formats for an uplink, a DCI format 0 for a single antenna and a DCI format 4 for multiple-input multiple-output (MIMO) are defined. A reception unit 111 carries out processing such as down-conversion and analog/digital (A/D) conversion for the received signal. In addition, the reception unit 111 performs detection of control information by blind decoding. The reception unit 111 outputs MCS information and frequency resource allocation information included in the control information, the PMI, a cyclic shift (CS) index that is applied to the DMRS, and MSS information. Here, the MSS information is information regarding the number of subframes allocated by one DCI format. However, in the case where the number of subframes allocated by one DCI format is one, the operation becomes the same as in the past. Furthermore, the numbers that can be specified as the number of subframes allocated by one DCI format are determined by transmission/reception. For example, the numbers may be 1, 2, 4, and 8, which are powers of two, may be 1, 2, 3, and 4, may be 1, 2, 4, 6, and 8, and may not be any of these examples.

An orthogonal sequence generation unit 113 determines the CS index (also referred to as a CS field) input from the reception unit 111 and the OCC used by the MSS information, the details of which will be described later on. A sequence of OCCs to be used, which is output by the orthogonal sequence generation unit 113, is input to a reference signal generation unit 112. The reference signal generation unit 112 generates a DMRS sequence on the basis of a cell ID and the CS index, performs multiplication by the sequence of OCCs input from the orthogonal sequence generation unit 113, and thereby generates a reference signal. Here, the DMRS sequence is generated in accordance with the following expression.

[Math. 1]

r̅_{H,V}(n)=x_{q}(n mod N^{RS}), 0≦n<M^{RS} expression (1)

Here, x_{q} is a Zadoff-Chu sequence, N^{RS} is the sequence length of the Zadoff-Chu sequence, and M^{RS} is the length of the DMRS signal sequence.

The CS is applied to the generated DMRS sequence in accordance with the following expression.

[Math. 2]

r_{u,v}^{(α}^{_{λ}}⁾(n)=e^{iα}^{_{λ}}ⁿr̅_{u,v}(n), 0≦n<M^{RS} expression (2)

Here, λ is a layer index, and α_{λ} is a CS rotation amount and is given by the following expression.

[Math. 3]

α_{λ}=2πn_{cs,λ}/12 expression (3)

n_{cs,λ} is given by the following expression.

[Math. 4]

n_{cs,λ}=(n_{DMRS}⁽¹⁾+n_{DMRS,λ}⁽²⁾+n_{PN}(n_{S}))mod 12 expression (4)

Here, n⁽¹⁾_{DMRS} is a common value across all layers notified by radio resource control (RRC) signaling, n⁽²⁾_{DMRS,λ} is a value that changes for each layer determined by the CS index notified by the DCI format, and n_{PN}(nₛ) is determined by the cell ID.

In a DMRS signal sequence to which CS has been applied, the OCC sequence is multiplied in accordance with the following expression.

[Math. 5]

r_{PUSCH}^{(λ)}(mM^{RS}+n)=w^{(λ)}(m)r_{N,V}^{(α}^{_{λ}}⁾(n),0≦n≦M^{RS}−1 expression (5)

Here, w^{(λ)} (m) is an OCC sequence, and m is a DMRS symbol number. For example, in the case where DMRSs are present in two OFDMs in one subframe, m=0, 1 and [w^{(λ)}(0) w^{(λ)}(1)] becomes [+1 +1] or [+1 −1].

For a DMRS signal sequence of a number of layers L (λ=0 to L−1) generated in accordance with expression (5), the precoding matrix used for data transmission and the same precoding matrix W are multiplied, and a DMRS signal sequence for each antenna port according to the following expression is obtained.

$$\begin{matrix}[ Math . 6 ] & \\ [ \begin{matrix}{\tilde{r}}_{PUSCH}^{( 0 )} \\ ⋮ \\ {\tilde{r}}_{PUSCH}^{( M - 1 )}\end{matrix} ] = W [ \begin{matrix}{r}_{PUSCH}^{( 0 )} \\ ⋮ \\ {r}_{PUSCH}^{( M - 1 )}\end{matrix} ] & expression ( 6 )\end{matrix}$$

The number of layers L and the number of antenna ports M of expression (6) may be the same value.

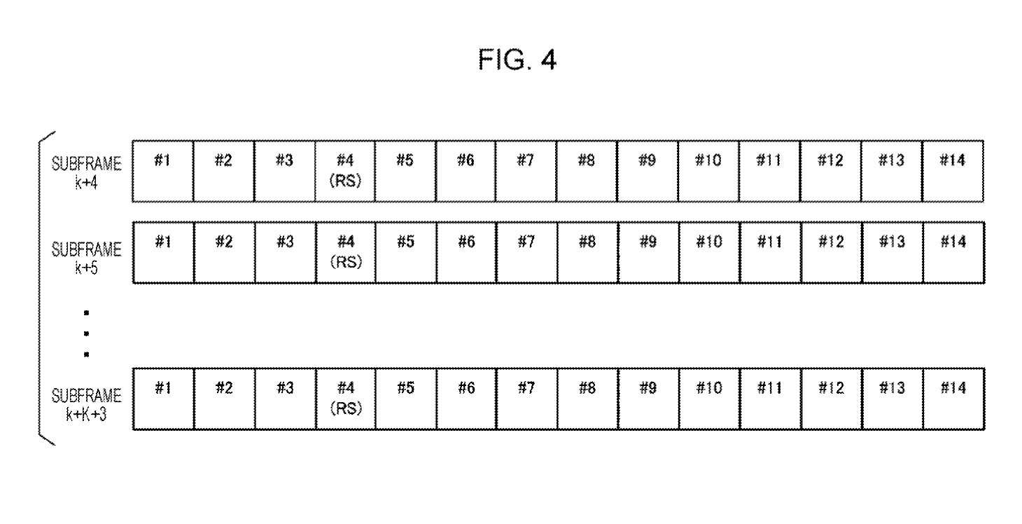

An example of a frame of MSS transmission data is depicted in FIG. 4. This drawing depicts the case where a terminal device receives DCI by a subframe #k, the timing of data transmission by a physical uplink shared channel (PUSCH) is taken as subframe #k+4, and the number of subframes allocated by MSS is taken as K, in which a DMRS is present in K symbols. In this case, an OCC sequence having a length K is input from the orthogonal sequence generation unit 113, and the pattern of the OCC sequence is applied to the RS of each subframe. For example, in the case where K=2 and the OCC sequence is [+1 −1], the DMRS signal sequence of subframe #k+4 is multiplied by “+1”, and the DMRS signal sequence of subframe #k+5 is multiplied by “−1”. The reference signal generation unit 112 outputs a DMRS sequence obtained by multiplication with OCCs to reference signal multiplexing units 106-1 to 106-M. However, with regard to the timing at which a data-transmitting subframe transmits an SRS, the reference signal generation unit 112 also generates and outputs an SRS signal sequence to the reference signal multiplexing units 106-1 to 106-M.

The signal allocation unit 105-1 arranges the signal sequence input from the precoding unit 104 in a frequency band on the basis of information regarding frequency resource allocation that has been input from the reception unit 111, and outputs to the reference signal multiplexing unit 106-1. The reference signal multiplexing unit 106-1 has the frequency-domain data signal sequence input thereto from the signal allocation unit 105-1, has a reference signal sequence input thereto from the reference signal generation unit 112, and generates a transmission signal frame by arranging these signal sequences as depicted in FIG. 4. An IFFT unit 107-1 has the frequency-domain transmission signal frame input thereto from the reference signal multiplexing unit 106-1, performs inverse fast Fourier transformation in units of each OFDM symbol, and thereby performs conversion from a frequency-domain signal sequence to a time-domain signal sequence. The time-domain signal sequence is output to a transmission processing unit 107-1.

The transmission processing unit 108-1 inserts a cyclic prefix (CP) into the time-domain signal sequence, performs conversion into an analog signal by digital/analog (D/A) conversion, and up-converts the converted signal into a wireless frequency used for transmission. The transmission processing unit 108-1 amplifies the up-converted signal with a power amplifier (PA), and transmits the amplified signal by way of a transmission antenna 109-1. The coding units 101-2 to 101-M to transmission antennas 109-2 to 109-M perform the same processing as in the above description. Furthermore, a description has been given with regard to the case where a terminal device performs data transmission with a plurality of antenna ports; however, the number of antenna ports may be 1.

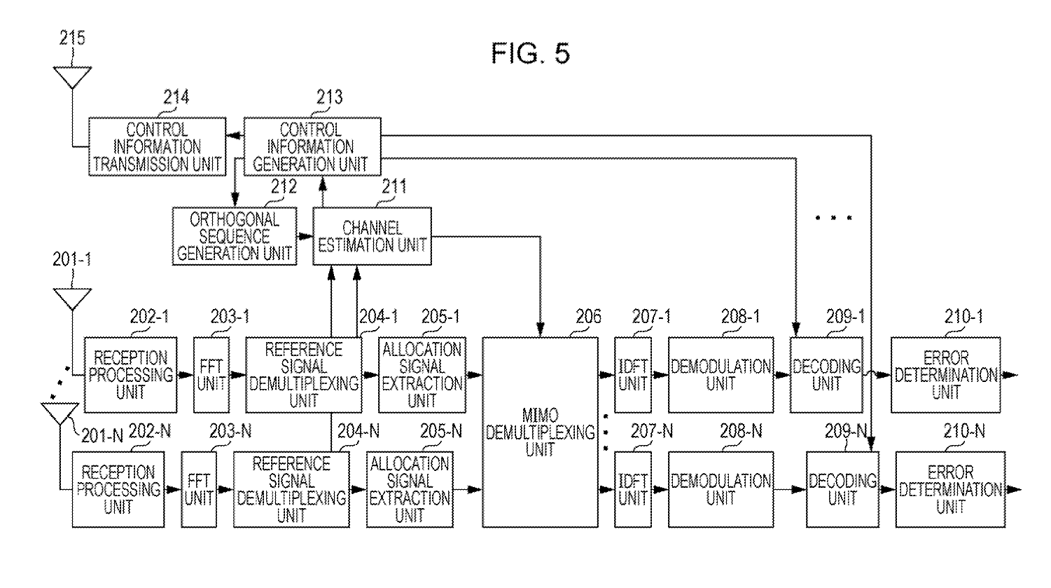

A schematic block diagram depicting an example of a configuration of a base station device according to the present invention is depicted in FIG. 5. In this drawing, the number of reception antennas used to receive data is taken as N. N is an integer that is equal to or greater than 1. Reception antennas 201-1 to 201-N receive signals transmitted from terminal devices, and input the reception signals to reception processing units 202-1 to 202-N. Hereinafter, the reception processing units 202-1 to 202-N to allocation signal extraction units 205-1 to 205-N perform the same processing, and therefore only the processing of the reception processing unit 202-1 to the allocation signal extraction unit 205-1 will be described.

The reception processing unit 202-1 down-converts a signal received by the reception antenna 201-1 into a baseband frequency, performs analog/digital (A/D) conversion with respect to the down-converted signal, and thereby generate a digital signal. In addition, the reception processing unit 202-1 removes a CP from the digital signal and outputs a reception signal sequence from which the CP has been removed to an FFT unit 203-1.

The FFT unit 203-1 converts the input reception signal sequence from a time-domain signal sequence into a frequency-domain signal sequence by fast Fourier transformation, and outputs the frequency-domain signal sequence to a reference signal demultiplexing unit 204-1. The reference signal demultiplexing unit 204-1 separates a reference signal sequence from the input frequency-domain signal sequence. The reference signal demultiplexing unit 204-1 inputs the separated reference signal sequence to a channel estimation unit 211, and inputs the remaining reception signal sequence after the reference signal sequence has been separated to the allocation signal extraction unit 205-1.

The channel estimation unit 211 has a reference signal sequence received from reference signal demultiplexing units 204-1 to 204-N input thereto, and has CS information and an OCC sequence used for each layer of the terminal devices input thereto from an orthogonal sequence generation unit 212. The channel estimation unit 211 multiplies the received reference signal sequence by the OCC sequence in the same way as the reference signal generation unit 112 of the terminal devices, adds DMRSs obtained by multiplication with the OCC sequence, and thereby extracts only reference signals in which the same OCC sequence is used. In addition, the channel estimation unit 211 demultiplexes DMRSs that have been multiplexed according to the CS, and thereby estimates a frequency response of each antenna port of the terminal devices, and outputs the frequency responses to a control information generation unit 213 and a MIMO demultiplexing unit 206. Here, in the case where an SRS is transmitted from a terminal device, the channel estimation unit 211 estimates a frequency response according to the SRS, and outputs the frequency response to the control information generation unit 213.

The control information generation unit 213 stores the input frequency response estimation values, and, according to the stored frequency response estimation values, determines control information to be notified to the terminal devices, which allocate a resource at the next transmission opportunity. The control information generation unit 213 generates control information in a prescribed DCI format from the determined control information, and outputs the control information to a control information transmission unit 214. Here, the control information determined by the control information generation unit 213 includes, for example, information regarding the frequency resource allocation, the MCS, the CS indexes applied to DMRSs, the PMI, and the MSS. The control information generation unit 213 outputs information regarding the CS indexes applied to DMRSs and the MSS to the orthogonal sequence generation unit 212. The orthogonal sequence generation unit 212 has information regarding the CS indexes and the MSS notified to terminal devices input thereto from the control information generation unit 213, generates an OCC sequence for each layer of the terminal devices, and outputs CS information and the OCC sequences to the channel estimation unit 211. The control information transmission unit 214 amplifies the control signal sequence input from the control information generation unit 213 to a prescribed transmission power, and then transmits the input control signal sequence by way of a transmission antenna 215.

Although not depicted, the allocation signal extraction unit 205-1 has information regarding frequency resource allocation input thereto from the control information generation unit 213, extracts a data signal sequence transmitted from a terminal device from a frequency-domain signal sequence, and inputs the data signal sequence to the MIMO demultiplexing unit 206. The MIMO demultiplexing unit 206 generates an equalization weight based on an MMSE model from a channel frequency response input from the channel estimation unit 211, multiplies the input frequency-domain data signal sequence by the weight, and thereby demultiplexes a MIMO-multiplexed signal. The MIMO demultiplexing unit 206 inputs the demultiplexed signal sequence to IDFT units 207-1 to 207-N. Here, N is an integer that is equal to or greater than 1. For signal processing in the MIMO demultiplexing unit 206, spatial filtering of another standard such as the zero forcing (ZF) standard, and another detection method such as maximum likelihood detection (MLD) may be applied.

The IDFT units 207-1 to 207-N convert the input signal sequence from the frequency domain into the time domain, and output to demodulation units 208-1 to 208-N, respectively. Although not depicted, the demodulation units 208-1 to 208-N have information regarding a modulation scheme input thereto from the control information generation unit 213, carry out demodulation processing with respect to the time-domain reception signal sequence, and obtain a bit sequence log-likelihood ratio (LLR), namely an LLR sequence. The demodulation units 208-1 to 208-N output the LLR sequence obtained by demodulation to decoding units 209-1 to 209-N. The decoding units 209-1 to 209-N have information regarding a coding rate input thereto from the control information generation unit 213, and perform decoding processing with respect to the LLR sequence. Error determination units 210-1 to 210-N hard-determine the input decoded LLR sequence for each code word, and obtain a bit string as transmission data in the case where there are no errors. Transmission signal sequences of terminal devices that performed data transmission in the same subframe are detected by the aforementioned processing.

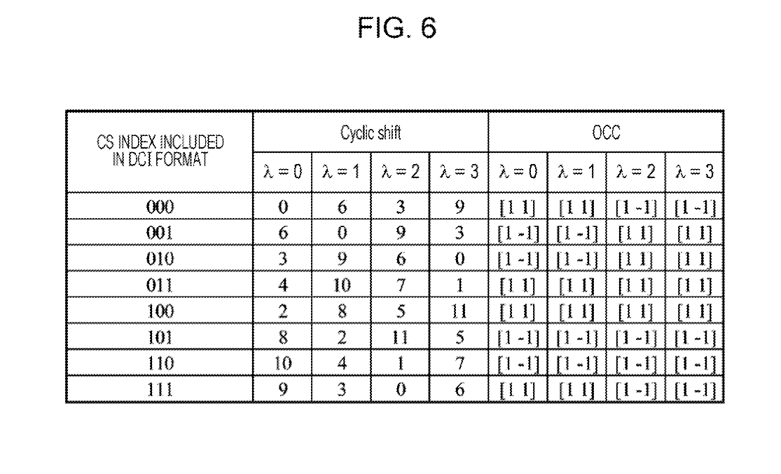

A conventional table of CS indexes and OCCs is depicted in FIG. 6. This drawing depicts a table of Rel. 10 of the LTE-A system. A CS index has three bits in the DCI format and indicates the CS and OCC applied to each layer. Here, λ indicates the layer. For example, in the case where “001” is notified in the DCI format, in layer 0 (λ=0) the CS becomes n⁽²⁾_{DMRS,λ}=6 and the OCC becomes [1 −1], and in layer 1 (λ=1) the CS becomes n⁽²⁾_{DMRS,λ}=0 and the OCC becomes [1 −1].

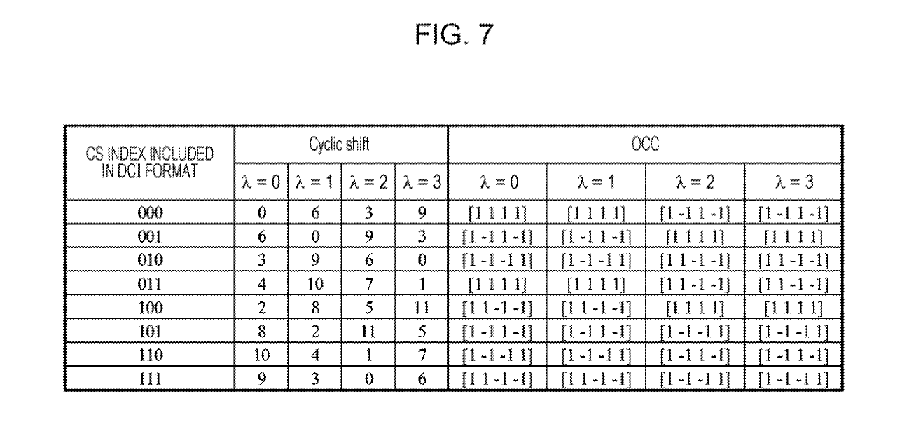

An example of a table of CS indexes and OCCs according to the first embodiment is depicted in FIG. 7. This drawing depicts the case where an OCC sequence is extended to four by a Walsh code. A description will be given with regard to the case where the table of FIG. 7 is used when the orthogonal sequence generation unit 113 of a terminal device generates an OCC sequence applied to a DMRS. First, the orthogonal sequence generation unit 113 determines which row of the table is to be used, in accordance with a CS index notified in the DCI format. Here, although there are four CSs and OCCs from layer 0 to 3, the location of the CS and OCC is determined by the number of layers used for data transmission. In the case where the number of transmission layers is two, reference is made to only the columns of λ=0 and λ=1. Next, the orthogonal sequence generation unit 113 determines the OCC sequence length according to the number of subframes that are scheduled by MSS. For example, in the case where resource allocation for two subframes is performed by a DMRS in only one OFDM symbol in one subframe, two sequences of the first half of the OCC sequence are used. For example, in the case where “001” is notified in the DCI format, [1 −1] is used in layer 0 (λ=0), [1 −1] is used in layer 1 (λ=1), [1 1] is used in layer 2 (?=2), and [1 1] is used in layer 3 (λ=3). As described above, the terminal device adaptively switches the OCC sequence length according to the number of OFDM symbols of DMRSs in which an OCC can be applied.

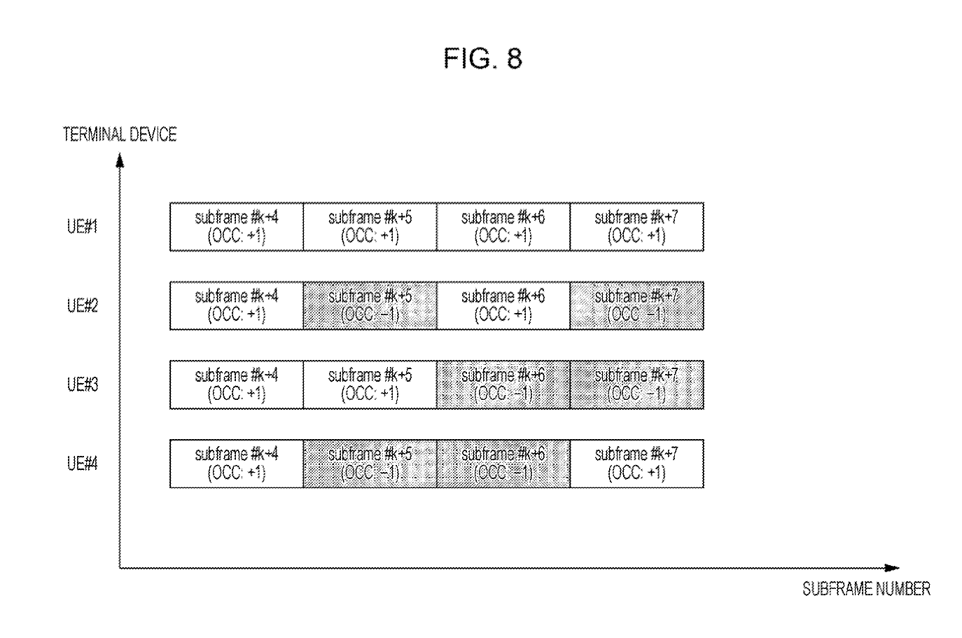

An example of the application of OCC sequences according to the first embodiment is depicted in FIG. 8. This drawing depicts the case where the number of terminal devices is four, and all terminal devices UE 1 to 4 are allocated four subframes by MSS. In this case, the OCC sequence length becomes four, and it therefore becomes possible for multiplexing to be performed by only OCCs. Therefore, multiplexing becomes possible with up to four users even in the case where demultiplexing by the CS cannot be performed such as in the case where the bandwidths (number of RBs) used by the terminal devices UE 1 to 4 are different and in the case where the bandwidths are the same but the RBs used do not match completely. Furthermore, in the case where the terminal devices UE 1 to 4 perform MIMO transmission, the DMRSs of the terminal devices are orthogonal due to the OCCs, and therefore demultiplexing is performed according to the CS among antennas.

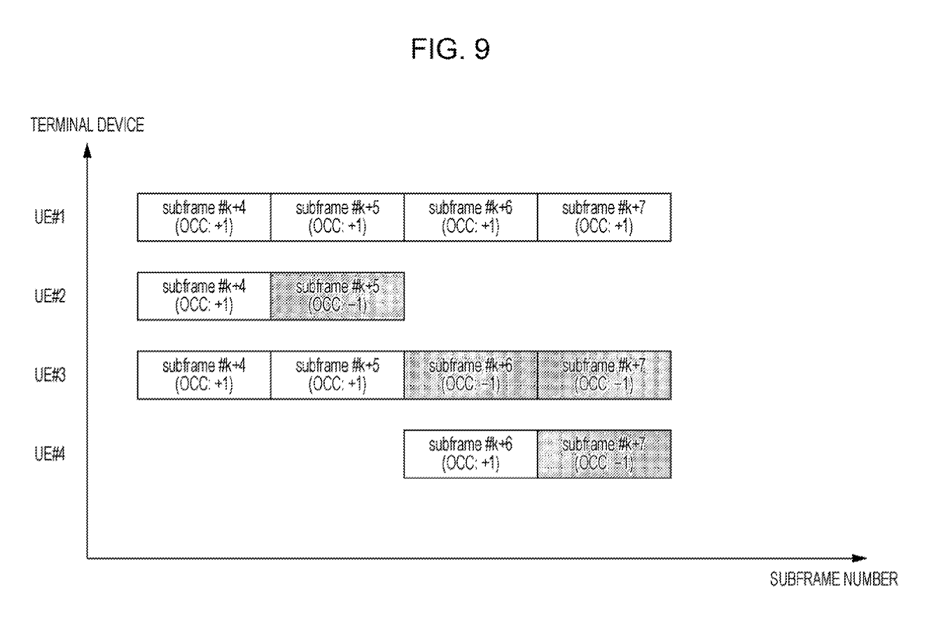

An example of the application of OCC sequences having different lengths according to the first embodiment is depicted in FIG. 9. Here, the number of terminal devices is four, the terminal devices UE 1 and 3 are allocated four subframes by MSS, and the terminal devices UE 2 and 4 are allocated two subframes. It is possible for DMRSs of three UEs to be made orthogonal in one RB of one subframe even in the case where the OCC sequence is adaptively changed as in this drawing.

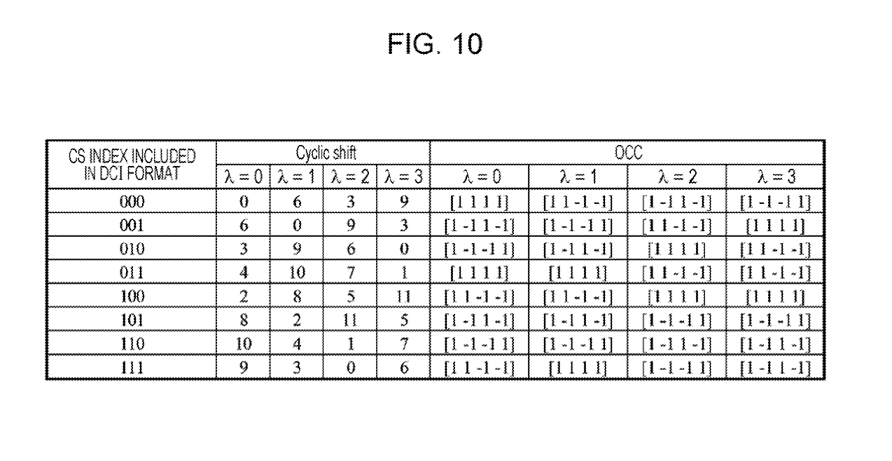

An example of a table of CS indexes and OCCs according to the first embodiment is depicted in FIG. 10. In the example depicted in FIG. 7, in the OCC sequences, layers 0 and 1 (λ=0 and 1) and layers 2 and 3 (λ=2 and 3) ordinarily have the same OCC sequence, and it is only possible to demultiplex according to the CS. In contrast thereto, in the example depicted in FIG. 10, with “000”, “001”, “010”, and “111” in the DCI format, different OCC sequences are allocated in layers 0 and 1 (λ=0 and 1), and it therefore becomes possible to demultiplex according to the OCCs. Furthermore, in the example depicted in FIG. 10, different OCC layers are also allocated in layers 2 and 3.

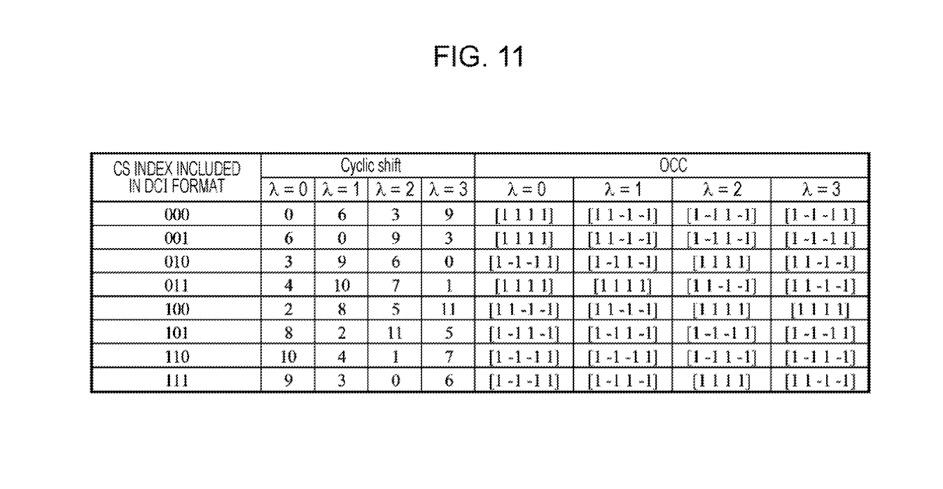

An example of a table of CS indexes and OCCs according to the first embodiment is depicted in FIG. 11. In the examples depicted in FIGS. 7 and 10, a sequence having a length of two of the first half of an OCC sequence having a length of four is the same as a conventional OCC sequence of FIG. 6, and has backward compatibility with conventional systems when used as an OCC sequence having a length of two. In contrast thereto, the example depicted in FIG. 11 does not have backward compatibility with “001” and “111” in the DCI format. A table such as that depicted in this drawing may be used.

In the present embodiment, a description has been given with regard to the case where an OCC sequence length of two or four is used; however, the present invention may also be applied in the case where the OCC sequence length is eight, the OCC sequence length may be extended by a Walsh code as long as the length is a power of two, and an OCC having a length of four may be repeatedly used. In such case, channel estimation is performed in units of the OCC sequence length. Furthermore, an example has been given in which an OCC sequence is determined in accordance with a CS index and the number of subframes allocated by MSS; however, an example of a table given in the present embodiment may be used in the case where the application of MSS is enabled by RRC signaling or feature group indicators (FGI), and the conventional table of FIG. 6 may be used in other cases. Furthermore, [1 1 1 1] may ordinarily be used when a radio network temporary identifier (C-RNTI) has not been set and a temporary C-RNTI has been set. An example of a table given in the present embodiment may be used in the case where a DMRS is constituted by one OFDM symbol in one subframe. Furthermore, with regard to carrier aggregation (CA) in which data transmission is performed with two or more component carriers (also referred to as a CC or a serving cell), a terminal device may determine an OCC sequence and sequence length in accordance with a CS index and the number of subframes allocated by MSS in each CC. In the present embodiment, it has been assumed that a Walsh code is used for an OCC orthogonal sequence; however, an orthogonal sequence due to phase rotation may also be used, and, in the case where the sequence length is four for example, a sequence of [1 πp/2 πp 3πp/2] in which p=0 to 3 and rotation is performed for each π/2 may be used. Furthermore, the present embodiment has been described based on the assumption that the MSS allocates continuous subframes; however, the MSS may periodically or non-periodically allocate a plurality of non-continuous subframes.

According to the above, in the present embodiment, the OCC sequence length is determined in accordance with the number of subframes allocated by MSS. As a result, it becomes possible to make an OCC sequence length to be longer than two, the number of terminal devices multiplexed can be increased, and DMRSs can be made orthogonal even among antennas of the same terminal device, and therefore throughput and spectral efficiency can be improved. In the present embodiment, a description has been given mainly of an example in which, in MSS, one DMRS is present in each subframe and an OCC is applied across a plurality of subframes; however, it should be noted that the present invention is not restricted thereto. For example, a subframe configuration may be implemented in which, although four continuous subframes are allocated by MSS, a DMRS is arranged only in the first and last subframes from among the four continuous subframes and a DMRS is not arranged in the second and third subframes. In this case, an OCC having a sequence length of two is applied in the first and last subframes.

### Second Embodiment

In a second embodiment of the present invention, a description is given of a case where, although the OCC sequence length is changed in accordance with the number of subframes allocated by MSS as in the aforementioned embodiment, the OCC sequence length is not a power of two.

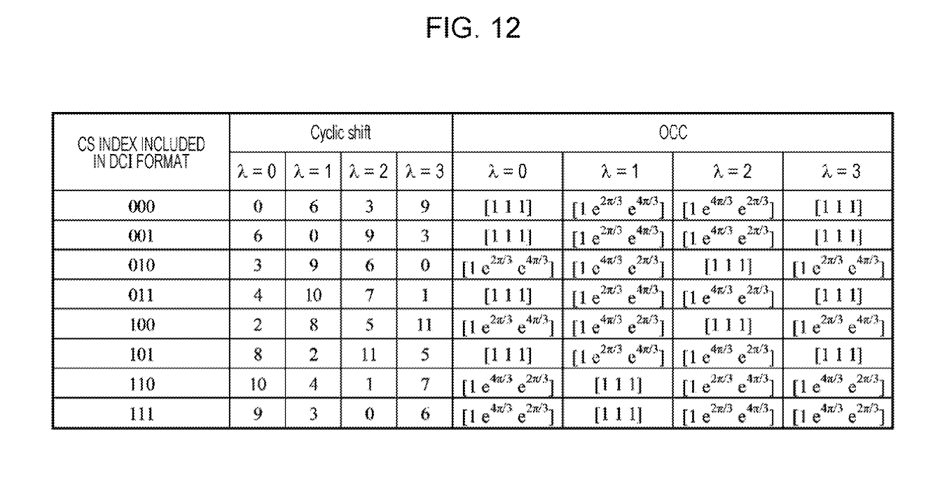

The configurations of the terminal devices and the base station device according to the second embodiment of the present invention are the same as in the aforementioned embodiment, and are as depicted in FIGS. 3 and 5, respectively. However, the OCC sequences generated by the orthogonal sequence generation unit 113 are different. First, an example of a table of CS indexes and OCCs according to the second embodiment is depicted in FIG. 12. This drawing depicts the case where the OCC sequence length is three, and can be used in the case where the DMRS is one OFDM symbol in one subframe, and the number of subframes allocated by MSS is three. Therefore, the orthogonal sequence generation unit 113 uses the table of FIG. 12 in the case where the number of subframes allocated by MSS is three, and uses the table of FIG. 6, which is a conventional system, or a table of the aforementioned embodiment in the case where the number of subframes allocated by MSS is two. Therefore, the table of CS indexes and OCCs to be used is switched in accordance with the number of subframes allocated by MSS.

Next, the processing of the orthogonal sequence generation unit 212 of the base station device in the present embodiment will be described. The orthogonal sequence generation unit 212 determines a table of CS indexes and OCCs in accordance with the number of subframes allocated by MSS in the same way as the terminal device. Here, processing that is different from that in the aforementioned embodiment is performed in the case where the number of subframes allocated is three. The orthogonal sequence generation unit 212 has information regarding a CS index and MSS notified to a terminal device input thereto from the control information generation unit 213, and generates an OCC sequence for each antenna port of the terminal device. Here, the orthogonal sequence generation unit 212 carries out complex conjugate processing with respect to the generated OCC sequences, and outputs to the channel estimation unit 211. As a result of this processing, streams in which a different OCC sequence is used are removed, and only DMRS signal sequences in which the same OCC sequence is applied are extracted. The processing besides the above is the same as in the aforementioned embodiment.

An exemplary application of the example of the table of CS indexes and OCCs of FIG. 12 in the present embodiment has been described in the case where the number of subframes allocated by MSS is three; however, it is also possible for the OCCs of FIG. 12 to be repeatedly used as long as the number of allocated subframes is a multiple of three.

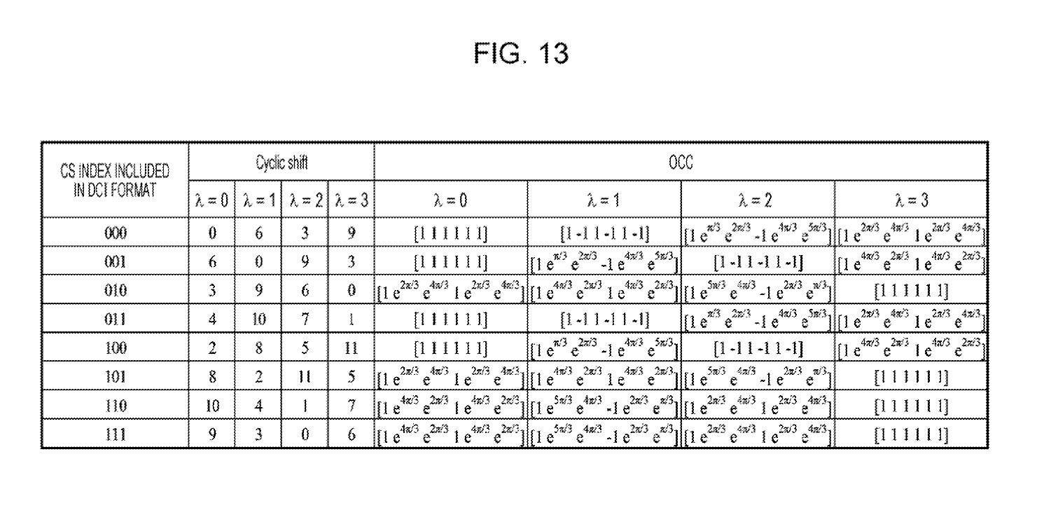

An example of another table of CS indexes and OCCs is depicted in FIG. 13. In this drawing, the OCC sequence length is six, and there are sequences with which multiplexing is possible also in the case of FIG. 12 where the OCC sequence length is three. In the case where the number of subframes allocated by MSS is six, OCC sequences having a length of six can be used, and it becomes possible to multiplex a maximum of six terminal devices by OCCs.

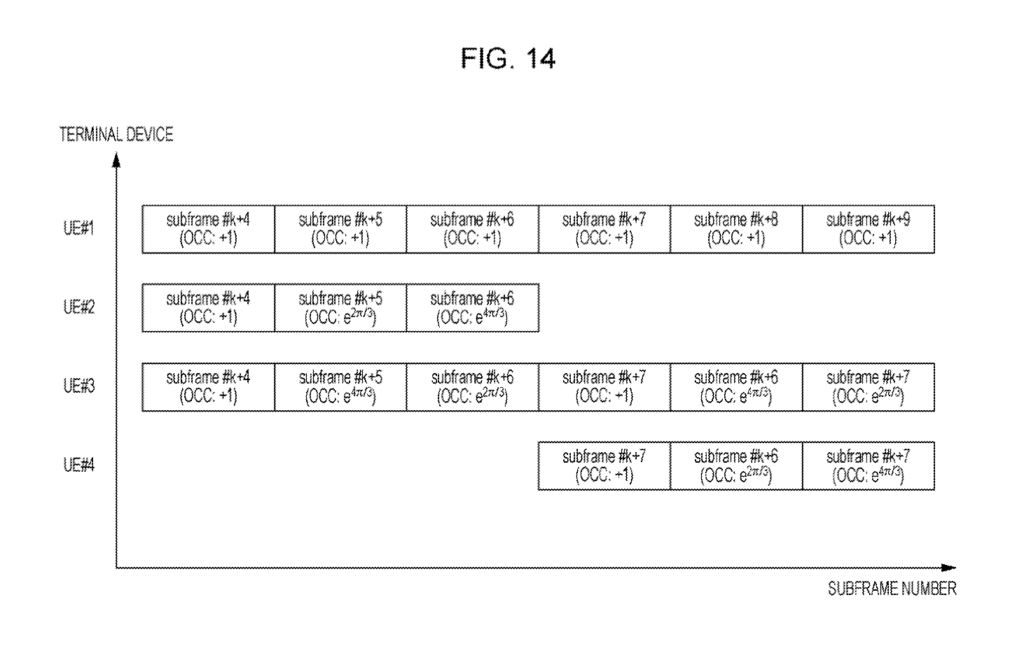

An example of the application of OCC sequences having different lengths according to the second embodiment is depicted in FIG. 14. Here, the number of terminal devices is four, the terminal devices UE 1 and 3 are allocated six subframes by MSS, and the terminal devices UE 2 and 4 are allocated three subframes. It becomes possible for the DMRSs of three UEs to be made orthogonal in one RB of one subframe even in the case where the OCC sequence is adaptively changed as in this drawing.

According to the above, in the present embodiment, the OCC sequence length is determined in accordance with the number of subframes allocated by MSS. As a result, it becomes possible to make an OCC sequence length to be longer than two, the number of terminal devices multiplexed can be increased, and DMRSs can be made orthogonal even among antennas of the same terminal device, and therefore throughput and spectral efficiency can be improved.

### Third Embodiment

In a third embodiment of the present invention, a description is given regarding an example where, although the OCC sequence length is changed in accordance with the number of subframes allocated by MSS as in the aforementioned embodiments, adaptive switching is performed including the case where the OCC sequence length is not a power of two.

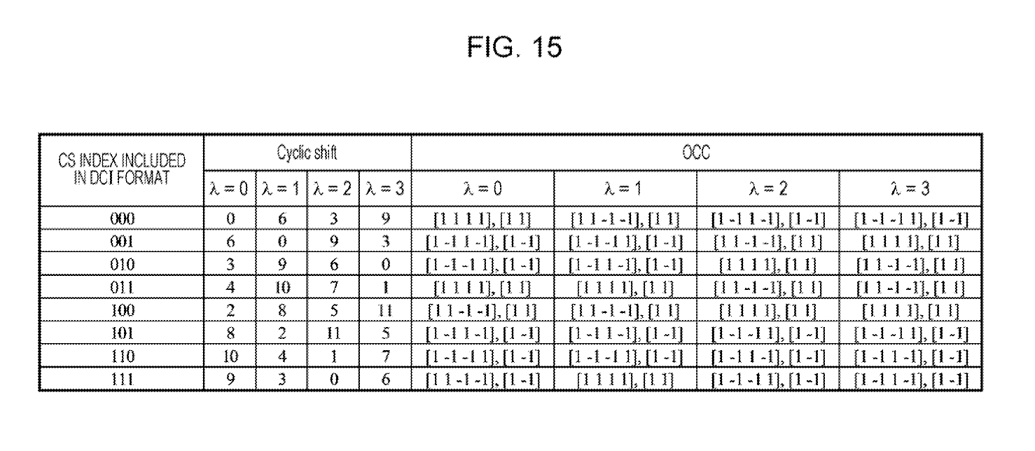

The configurations of the terminal device and the base station device according to the third embodiment of the present invention are the same as in the first embodiment, and are as depicted in FIGS. 3 and 5, respectively. However, the OCC sequences generated by the orthogonal sequence generation unit 113 are different. First, an example of a table of CS indexes and OCCs according to the third embodiment is depicted in FIG. 15. This drawing depicts the case where the maximum OCC sequence length is six, and can be used in the case where the DMRS is one OFDM symbol in one subframe, and the number of subframes allocated by MSS is two, four, or six. In the example of FIG. 15, the same sequences as those of FIG. 10 are selected in the case where the number of subframes allocated by MSS is two or four, and the orthogonal sequence generation unit 113 performs the same processing as that in the first embodiment. Next, in the case where the number of subframes allocated by MSS is six, the orthogonal sequence generation unit 113 selects OCC sequences configured of Walsh codes having lengths of four and two when the example of FIG. 15 is used.

The processing of the orthogonal sequence generation unit 212 of the base station device in the present embodiment will be described. The orthogonal sequence generation unit 212 performs the same processing as that in the first embodiment in the case where the number of subframes allocated by MSS is two or four. In the case where the number of subframes allocated by MSS is six, the orthogonal sequence generation unit 212 performs channel estimation divided into four first-half subframes and two second-half subframes. That is, the OCC sequences of FIG. 15 combine Walsh codes having lengths of four and two, which therefore means that channel estimation is performed in units of Walsh code lengths.

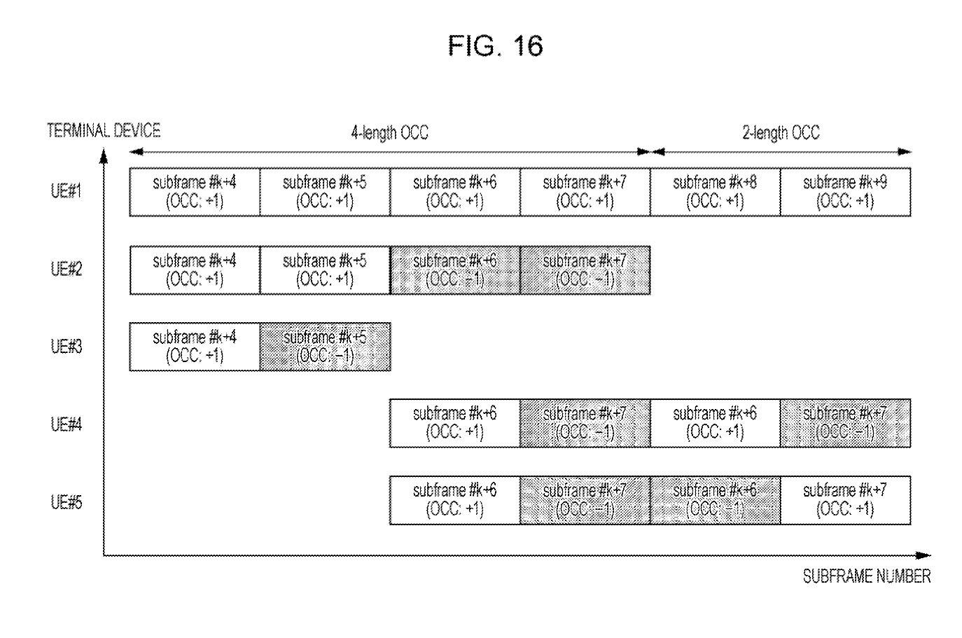

An example of the application of OCC sequences having different lengths according to the third embodiment is depicted in FIG. 16. Here, the number of terminal devices is five, the terminal device UE 1 is allocated six subframes by MSS, the terminal devices UE 2, 4, and 5 are allocated five subframes, and the terminal device UE 3 is allocated two subframes. It is possible for DMRSs of four UEs to be made orthogonal in one RB of one subframe even in the case where the OCC sequences are adaptively changed as in this drawing.

In the present embodiment, it has been assumed that Walsh codes are used for the orthogonal sequence of OCCs having a length of four and a length of two; however, orthogonal sequences obtained by phase rotation may also be used as orthogonal sequences having a length of four, and, in the case where the sequence length is four for example, a sequence of [1 πp/2 πp 3πp/2] in which p=0 to 3 and rotation is performed for each π/2 may be used.

According to the above, in the present embodiment, the OCC sequence length is determined in accordance with the number of subframes allocated by MSS. As a result, it becomes possible to make an OCC sequence length to be longer than two, the number of terminal devices multiplexed can be increased, and DMRSs can be made orthogonal even among antennas of the same terminal device, and therefore throughput and spectral efficiency can be improved.

### Fourth Embodiment

In the first to third embodiments, a case is assumed in which a DMRS present in one subframe is one OFDM symbol; however, in the present embodiment, the number of OFDM symbols of DMRSs present in one subframe can vary, and a description is given with regard to a case where setting can be performed specific to a CC (serving cell) and the case where setting can be performed specific to a terminal device.

The configurations of the terminal device and the base station device according to the fourth embodiment of the present invention are the same as in the first embodiment, and are as depicted in FIGS. 3 and 5, respectively. However, the OCC sequences generated by the orthogonal sequence generation unit 113 are different. The orthogonal sequence generation unit 113 has input thereto the number N_{DMRS} of OFDM symbols of DMRSs present in one subframe and the number N_{subframe} of subframes allocated in accordance with MSS and a value notified by control information such as RRC or DCI. The orthogonal sequence generation unit 113 determines the OCC sequence length N_{OCC} to be selected, in accordance with the following expression.

N_{OCC}=N_{DMRS}N_{subframe} expression (7)

The orthogonal sequence generation unit 113 uses the table of CS indexes and OCCs of an example given in the first embodiment or the third embodiment in the case where N_{occ}=4 according to expression (7), and uses the table of CS indexes and OCCs of an example given in the second embodiment or the third embodiment in the case where N_{occ}=6.

According to the above, in the present embodiment, the OCC sequence length is determined in accordance with the number of subframes allocated by MSS. As a result, it becomes possible to make an OCC sequence length to be longer than two, the number of terminal devices multiplexed can be increased, and DMRSs can be made orthogonal even among antennas of the same terminal device, and therefore throughput and spectral efficiency can be improved.

It should be noted that a portion of the terminal device and base station device according to the aforementioned embodiments may be realized by a computer. In such case, a program for realizing this control function may be recorded on a computer-readable recording medium, and the control function may be implemented by causing the program recorded on this recording medium to be read by a computer system and executed. It should be noted that a “computer system” referred to here is a computer system that is provided within the terminal device or the base station device, and includes an OS and hardware such as a peripheral device. Furthermore, a “computer-readable recording medium” refers to a portable medium such as a flexible disk, a magneto-optical disk, a ROM, and a CD-ROM, and a storage device such as a hard disk provided within the computer system. In addition, a “computer-readable recording medium” may also include a medium that dynamically retains a program for a short period of time as in a communication line in the case where a program is transmitted via a network such as the Internet or a communication line such as a telephone line, and a medium that retains a program for a fixed time as in a volatile memory within a computer system constituting a server or a client in the aforementioned case. Furthermore, the aforementioned program may be a program that realizes some of the previously mentioned functions, and, in addition, may be a program that can realize the previously mentioned functions in combination with a program already recorded in the computer system.

Furthermore, a portion or the entirety of the terminal device and base station device according to the aforementioned embodiments may be realized as an integrated circuit such as a large scale integration (LSI). Each functional block of the terminal device or the base station device may be individually implemented as a processor, or a portion or the entirety thereof may be integrated and implemented as a processor. Furthermore, the technique for implementation as an integrated circuit is not limited to an LSI, and may be realized using a dedicated circuit or a general-purpose processor. Furthermore, in the case where a technology for implementation as an integrated circuit that is an alternative to LSI comes into existence due to the development of semiconductor technology, an integrated circuit according to that technology may be used.

An embodiment of this invention has been described in detail hereinabove with reference to the drawings; however, the specific configuration is not restricted to the aforementioned, and it is possible to implement various design changes or the like within a scope that does not deviate from the gist of this invention.

### INDUSTRIAL APPLICABILITY

An aspect of the present invention can be applied in a terminal device, a base station device, a wireless communication system, a communication method, or the like in which it is necessary to increase the number of users multiplexed and it is necessary to improve spectral efficiency.

### REFERENCE SIGNS LIST

101-1 to 101-L Coding unit
102-1 to 102-L Modulation unit
103-1 to 103-L DFT unit
104 Precoding unit
105-1 to 105-M Signal allocation unit
106-1 to 106-M Reference signal multiplexing unit
107-1 to 107-M IFFT unit
108-1 to 108-M Transmission processing unit
109-1 to 109-M Transmission antenna
110 Reception antenna
111 Reception unit
112 Reference signal generation unit
113 Orthogonal sequence generation unit
201-1 to 201-N Reception antenna
202-1 to 202-N Reception processing unit
203-1 to 203-N FFT unit
204-1 to 204-N Reference signal demultiplexing unit
205-1 to 205-N Allocation signal extraction unit
206 MIMO demultiplexing unit
207-1 to 207-N IDFT unit
208-1 to 208-N Demodulation unit
209-1 to 209-N Decoding unit
210-1 to 210-N Error determination unit
211 Channel estimation unit
212 Orthogonal sequence generation unit
213 Control information generation unit
214 Control information transmission unit
215 Transmission antenna

1. A terminal device that receives a frequency resource allocation for data transmission configured of a plurality of subframes and notified from a base station device,
the terminal device being provided with an orthogonal sequence generation unit that generates an orthogonal sequence to be applied to a reference signal, in accordance with a number of the plurality of subframes allocated.

2. The terminal device according to claim 1, wherein
the orthogonal sequence generation unit determines a length of the orthogonal sequence to be generated, in accordance with the number of the plurality of subframes allocated.

3. The terminal device according to claim 2, wherein
the orthogonal sequence generation unit implements the orthogonal sequence to be applied, as a Walsh code.

4. The terminal device according to claim 2, wherein
the orthogonal sequence generation unit switches the orthogonal sequence to be applied to the reference signal, between a Walsh code and an orthogonal sequence generated by phase rotation, in accordance with the number of the plurality of subframes allocated.

5. The terminal device according to claim 2, wherein
the orthogonal sequence generation unit switches the orthogonal sequence to be applied to the reference signal, between one orthogonal sequence and a combination of a plurality of orthogonal sequences, in accordance with the number of the plurality of subframes allocated.

6. The terminal device according to claim 2, wherein
the orthogonal sequence generation unit determines the length of the orthogonal sequence to be applied to the reference signal, in accordance with the number of the plurality of subframes allocated and a number of symbols of a demodulation reference signal present in one subframe.

7. A transmission method in which a frequency resource allocation for data transmission configured of a plurality of subframes and notified from a base station device is received and data transmission is performed, the transmission method including:
a step in which an orthogonal sequence length is determined in accordance with a number of the plurality of subframes allocated;
a step in which a sequence having the determined orthogonal sequence length is generated; and
a step in which a transmission signal is generated by a step in which a reference signal is multiplied by the generated orthogonal sequence.
